(19) United States
(12) Patent Application Publication
(10) Pub. No.: US 2010/0259847 A1
(43) Pub. Date: Oct. 14, 2010

(54) PORTABLE APPARATUS HAVING ELECTRONIC CONTROL SYSTEM AND CONTROL METHOD THEREOF

(75) Inventors: SHU-CHEN CHANG, Taipei (TW); TI-CHENG HSU, Taipei (TW); CHING-TSAI CHANG, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: ELITEGROUP COMPUTER SYSTEMS CO., LTD., Taipei (TW)

(21) Appl. No.: 12/822,200

(22) Filed: Jun. 24, 2010

Related U.S. Application Data
(60) Provisional application No. 61/289,406, filed on Dec. 23, 2009.

(30) Foreign Application Priority Data
Nov. 26, 2008 (TW) 099107518

(51) Int. Cl. G11B 21/02

(52) U.S. Cl. 360/75; G9B/21.003

(57) ABSTRACT

A portable apparatus having an electronic control system and a control method thereof are provided. The portable apparatus comprises an operation system, an accessing device and a basic input/output system (BIOS), and the electronic control system comprises a G-sensor and an embedded controller (EC) for initializing the G-sensor, wherein the G-sensor senses the acceleration of the portable apparatus and compares the acceleration value with the threshold value. The operation system comprises an application program (AP) and an advanced configuration and power interface (ACPI). When the acceleration value is higher than the threshold value, the G-sensor sends out a first signal to the EC, and the EC sends out a second signal to the BIOS, and the BIOS sends out a third signal to the ACPI, and the ACPI sends out a fourth signal to the AP to give a park command for parking the reading head of the accessing apparatus.

### CROSS-REFERENCE TO RELATED APPLICATIONS

This U.S. non-provisional patent application claims priority under 35 U.S.C. §119 of

Taiwan Patent Application No.099107518, filed on Nov. 26, 2008, the entire contents of which are hereby incorporated by reference.

### BACKGROUND OF THE INVENTION

1. Field of the Invention

The present invention relates to a portable apparatus having an electronic control system and a control method thereof; in particular, the present invention relates to a portable apparatus having an electronic control system and a control method thereof for preventing the damage of the motor drive unit from abnormal acceleration in notebook field.

2. Description of Related Art

At present, portable apparatuses, such as the mp3 walkman, cell phone and notebook etc. are becoming more and more essential for daily use in modem society. The frequency of using the portable electronic apparatus is very high, and using the portable electronic apparatus is not restricted to occasions and time, such as in the moving car, walking on the road and even on the process of intense exercise. Therefore, in the process of using these portable apparatus, the components inside the apparatus will collide or rub against each other and cause the damage of the apparatus due to the negligence of the user or the abnormal movement. Among the general electronic apparatuses, the hard disk drives (HDD) are generally acknowledged the most easily damaged apparatus due to collision or dropping. For this reason, many of the prior techniques and solutions are developed to protect this apparatus. There are two directions in the solutions in general. One is to wrap the cushioning material or cushion structure around the outside of the HDD to decrease the shock during the collision, and the other is the method of using electronic control to protect the apparatus.

Among the electronic control methods, the U.S. Pat. No. 5,227,929 patent discloses a protection mechanism and a protection system for protecting the hard disk from the damage of the collision shock. A sense element used in this patent is a three-axis accelerometer. After processing the signal, the processing unit will order the system to park the reading head of the HDD to prevent the disk of the HDD from the collision of the reading head.

The Taiwan patents I256053, I280570, I292876 disclose similar solutions one after another. In the I256053 patent, an acceleration sensor is used to provide an action signal, and the action signal will be converted to a digital signal by a processing unit. When the action of the apparatus exceeds the threshold value, the processing unit will disconnect the power to stop the HDD. The I280570 patent discloses a protecting circuit including a central processing unit and a sense unit for sensing the action of the X axis and the Y axis. When the instantaneous displacement of the X axis and the Y axis reach certain degree, the central processing unit will force the protection of the HDD. The instantaneous displacement of the X axis and the Y axis are neither the components of the X/Y/Z axis nor the changes in acceleration in this patent, such that the scope of the patent is to detect the X axis, the Y axis and the instantaneous displacement of the X axis and the Y axis. The I292876 patent provides a three-axis control method combining the electronic device and the control module. The difference between this patent and the former patents is that the detecting method of the patent is not to calculate whether the threshold value exceeds the standard or not, but compares to find out the data difference by using a database to determine whether to trigger the control signal to control the electronic apparatus or not. The disclosure scope of the patent does not mention that the electronic control can be used to stop action of the HDD, but the electronic control method also may be a solution of protecting HDD.

### SUMMARY OF THE INVENTION

In view of the issue of the prior technique mentioned above, one objective of the present invention is to provide a portable apparatus having an electronic control system and a control method thereof to solve the problem of the HDD protection that the prior HDD protection technique can not immediately and reliably protect the HDD.

In accordance with the objective of the present invention, a portable apparatus having an electronic control system is provided, wherein the electronic control system is disposed inside the portable apparatus and comprises at least an accessing device and a basic input/output system. The accessing device has a motor drive unit and stores an operation system. The electronic control system is suitable for preventing the damage of the motor drive unit from abnormal acceleration and comprises a G-sensor and an embedded controller, wherein the G-sensor is disposed in the portable apparatus and suitable for sensing the acceleration of the portable apparatus to compare at least an acceleration value with one of the threshold values, and the embedded controller is disposed in the portable apparatus and connected to the G-sensor for receiving at least a first signal provided from the G-sensor and providing at least a second signal. The operation system stored in the accessing device comprises an application program (AP) and an advanced configuration and power interface (ACPI), wherein the advanced configuration and power interface is suitable for receiving at least a third signal provided from the basic input/output system and providing at least a fourth signal, and the application program is suitable for receiving the fourth signal and sending out a park command. When the acceleration value is higher than the threshold value, the first signal is sent out to the embedded controller from the G-sensor, the second signal is sent out to the basic input/output system from the embedded controller, the third signal is sent out to the advanced configuration and power interface from the basic input/output system and the fourth signal is sent out from the advanced configuration and power interface to control the application program to send out the park command to the accessing device for parking the reading head of the accessing device.

In accordance with the objective of the present invention, a control method of a portable apparatus having an electronic control system is provided, wherein the electronic control system is disposed inside the portable apparatus and comprises a G-sensor and an embedded controller. The portable apparatus comprises at least an accessing device and a basic input/output system, wherein the accessing device has a motor drive unit and stores an operation system such that the operation system has an application program and an advanced configuration and power interface. The control method of the portable apparatus is suitable for preventing the damage of the motor drive unit from abnormal acceleration, and comprises the following steps: the embedded controller initializing the G-sensor; the G-sensor sensing the acceleration of the portable apparatus to provide at least an acceleration value to compare the acceleration value with one of the threshold values stored in the G-sensor; the G-sensor providing a first signal if the acceleration value is higher than the threshold value; the embedded controller receiving the first signal and providing at least a second signal wherein the embedded controller is disposed in the portable apparatus and connected to the G-sensor; the basic input/output system receiving the second signal and providing at least a third signal; and the advanced configuration and power interface receiving the third signal and providing at least a fourth signal to control the application program sending out a park command to the accessing device for parking the reading head of the accessing device.

As mentioned previously, the portable apparatus having the electronic control system and the control method of the portable apparatus of the present invention have the following advantages:

(1) protecting the data security of the accessing device such like HDD via sensing the acceleration value by the G-sensor in the portable apparatus having the electronic control system and the control method thereof; and

(2) sensing the turning state of the portable apparatus via the G-sensor to display the corresponding image of the monitor of the portable apparatus in the portable apparatus having the electronic control system and the control method thereof.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a block diagram of a portable apparatus having an electronic control system in accordance with an embodiment of the present invention;

FIG. 2 is a schematic view of the accessing device in accordance with an embodiment of the present invention;

FIG. 3 is a schematic view of a portable apparatus in accordance with another embodiment of the present invention; and

FIG. 4 is a flow chart of a control method of a portable apparatus having an electronic control system in accordance with an embodiment of the present invention.

### DETAILED DESCRIPTION OF THE PREFERRED EMBODIMENTS

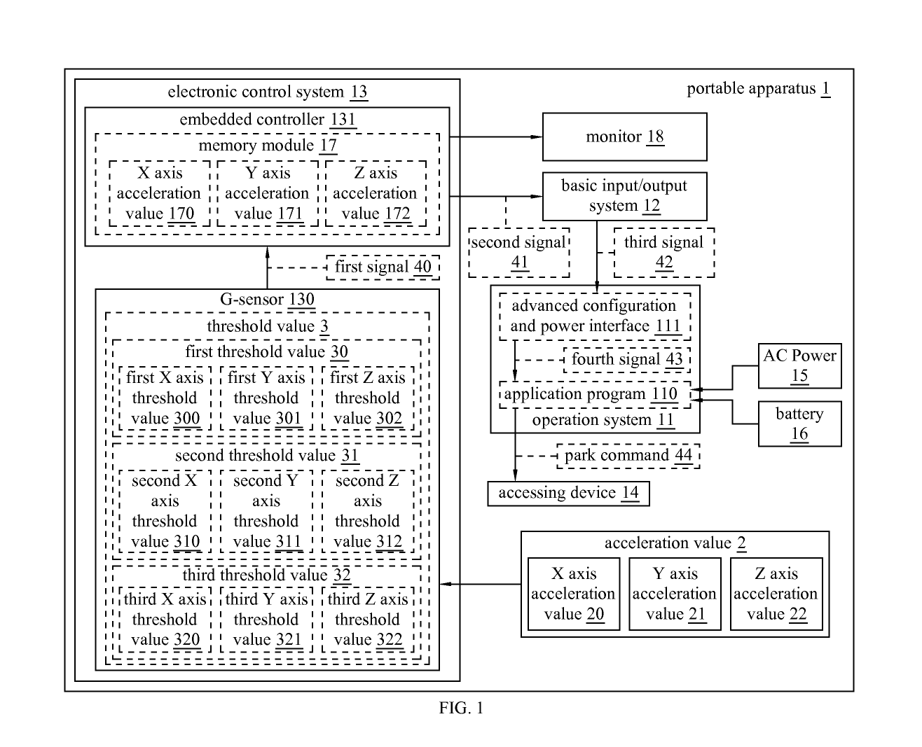

Please refer to FIG. 1 for a block diagram of a portable apparatus having an electronic control system in accordance with an embodiment of the present invention. In the figure, the portable apparatus 1 comprises an operation system (OS) 11, a basic input/output system (BIOS) 12, an electronic control system 13, an accessing device 14, an AC Power 15, a battery 16 and a monitor 18, wherein the operation system 11 is stored in the accessing device 14, and the electronic control system 13 comprises a G-sensor 130 and an embedded controller (EC) 131. The G-sensor 130 is disposed inside the portable apparatus 1 and suitable for sensing the acceleration of the portable apparatus 1 to provide at least an acceleration value 2 and compare the acceleration value 2 with one of the threshold values 3. The embedded controller 131 is disposed in the portable apparatus 1 and connected to the G-sensor 130. The operation system 11 comprises an application program (AP) 110 and an advanced configuration and power interface (ACM) 111. The application program 110 is used to send out a park command to the accessing device 14 to park the reading head of the accessing device 14, and the advanced configuration and power interface 111 is used to receive the signal of the basic input/output system 12 to control the application program 110 to actuate the accessing device 14. When the acceleration value 2 is higher than the threshold value 3, the G-sensor 130 is used to send out at least a first signal 40 to the embedded controller 131, the embedded controller 131 is used to send out at least a second signal 41 to the basic input/output system 12, the basic input/output system 12 is used to send out at least a third signal 42 to the advanced configuration and power interface 111 and the advanced configuration and power interface 111 is used to send out a fourth signal to control the application program 110 to send out a park command 44 to the accessing device 14 to park the reading head of the accessing device 14.

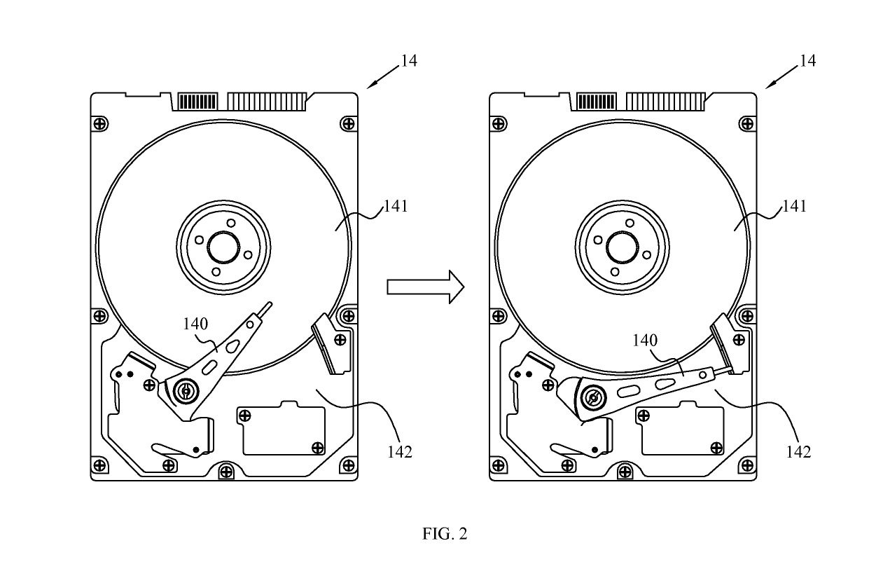

Furthermore, the acceleration value 2 comprises an X axis acceleration value 20, a Y axis acceleration value 21 and a Z axis acceleration value 22. A plurality of the threshold values 3 comprises a first threshold value 30, a second threshold value 31 and a third threshold value 32. The first threshold value 30 comprises a first X axis threshold value 300, a first Y axis threshold value 301 and a first Z axis threshold value 302, the second threshold value 31 comprises a second X axis threshold value 310, a second Y axis threshold value 311 and a second Z axis threshold value 312 and the third threshold value 32 comprises a third X axis threshold value 320, a third Y axis threshold value 321 and a third Z axis threshold value 322. In one embodiment, the application program 110 orders the embedded controller 131 to control the G-sensor 130 comparing the acceleration value 2 with one of the first threshold values 30 while the portable apparatus 1 is connected to the AC power 15. In another embodiment, the application program 110 orders the embedded controller 131 to control the G-sensor 130 comparing the acceleration value 2 with one of the second threshold values 31 while the portable apparatus 1 is connected to the battery 16. The comparing method is to compare the X axis acceleration value 20 with the first X axis threshold value 300 or the second X axis threshold value 310 and so on. While any acceleration value exceeds the threshold value in the X axis, the Y axis or the Z axis, the G-sensor 130 sends out the first signal to embedded controller 131, and then the embedded controller 131 sends out the second signal 41 to the basic input/output system 12, and then the basic input/output system 12 sends out the third signal 42 to the advanced configuration and power interface 111, and then the advanced configuration and power interface 111 sends out the fourth signal 43 to the application program 110 to send out a park command 44 to the accessing device 14 to park the reading head1 140. As shown in the FIG. 2, the reading head 140 of the accessing device 14 (like HDD) is removed from the disk 141 and then placed in a parking space 142.

It is worth mentioning that a user usually put the portable apparatus 1 (like notebook) stationary on the table while using the AC Power 15 such that the portable apparatus 1 will not suffer too much shock. On the contrary, the user usually uses the portable apparatus 1 on the moving while using the battery 16 such that the shock probability will be raised. Thus, the second threshold value 31 is set to be higher than the first threshold value 30. In other words, the sensitivity of sensing acceleration need to be higher (lower threshold value) while in stationary using situation, and the sensitivity of sensing acceleration need to be lower while in moving situation, and the setting can reduce the case of error detection.

In another preferred embodiment, the embedded controller 131 disposed in the electronic control system 13 further comprises a memory module 17 connected to the G-sensor 130 and recording the acceleration value 2. The threshold value 3 further comprises a third threshold value 32, and the third threshold value 32 comprises a third X axis threshold value 320, a third Y axis threshold value 321 and a third Z axis threshold value 322, wherein the third X axis threshold value 320 is an average value of the X axis acceleration values 170 stored in the memory module 17, the third Y axis threshold value 321 is an average value of the Y axis acceleration values 171 stored in the memory module 17 and the third Z axis threshold value 322 is an average value of the Z axis acceleration values 172 stored in the memory module 17. In the present embodiment, the user can set the memory module 17 to open and record the acceleration values in a period of time as the method of the driving recorder, and then the memory module 17 processes a statistical treatment on the acceleration values in this period of time to obtain the threshold value as the specific threshold value used in the airplane or in the small car. Thus, the user can easily protect the accessing device 14 from damage due to the large external force shock in different situation.

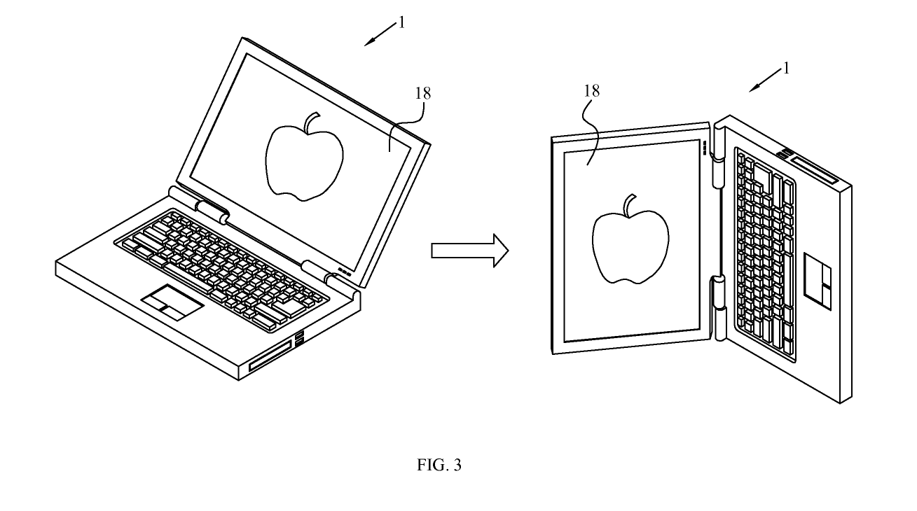

Besides, please refer the FIG. 3, portable apparatus 1 further comprises a monitor 18 connected to the embedded controller 131. If the embedded controller 131 detects the portable apparatus 1 to be turned around, the embedded controller 131 turns around the image displayed on the monitor 18 accordingly.

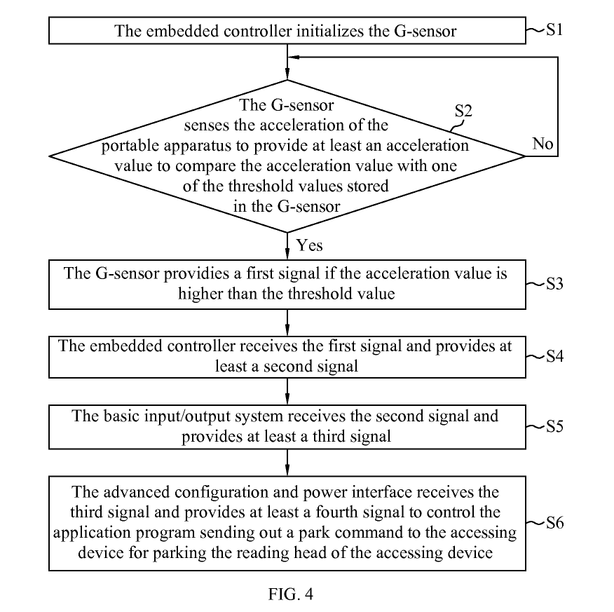

Please refer the FIG. 4 for a flow chart of a control method of a portable apparatus having an electronic control system in accordance with an embodiment of the present invention. The electronic control system is disposed inside the portable apparatus and comprises a G-sensor and an embedded controller. The portable apparatus comprises at least an accessing device and a basic input/output system, wherein the accessing device has a motor drive unit and stores an operation system such that the operation system has an application program and an advanced configuration and power interface. The control method of the portable apparatus is suitable for preventing the damage of the motor drive unit from abnormal acceleration, and comprises the following steps: (S1) initializing the G-sensor by the embedded controller; (S2) sensing the acceleration of the portable apparatus with the G-sensor to provide at least an acceleration value to compare the acceleration value with one of the threshold values stored in the G-sensor; (S3) providing a first signal by the G-sensor if the acceleration value is higher than the threshold value; (S4) receiving the first signal and providing at least a second signal by the embedded controller; (S5) receiving the second signal and providing at least a third signal by the basic input/output system; and (S6) receiving the third signal and providing at least a fourth signal by the advanced configuration and power interface to control the application program sending out a park command to the accessing device for parking the reading head of the accessing device. The detail illustrations of the steps are similar as mentioned above and will be omitted here.

In the portable apparatus having the electronic control system and the control method of the portable apparatus of the present invention, the G-sensor senses the acceleration value and compares the acceleration value with each threshold value in different usage situation to achieve the goal of protecting the accessing device such as HDD security. Besides, the G-sensor senses the turning state of the portable apparatus to display the corresponding image of the monitor of the portable apparatus.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A portable apparatus having an electronic control system disposed inside the portable apparatus, comprising:
a basic input/output system (BIOS) and at least an accessing device having a motor drive unit and storing an operation system;
the electronic control system suitable for preventing the damage of the motor drive unit from abnormal acceleration, comprising:
a G-sensor disposed in the portable apparatus and suitable for sensing the acceleration of the portable apparatus to provide at least an acceleration value according to the acceleration of the portable apparatus, and comparing the acceleration value with one of the threshold values stored in the G-sensor;
an embedded controller (EC) disposed in the portable apparatus and connected to the G-sensor for initializing the G-sensor, receiving at least a first signal provided from the G-sensor and providing at least a second signal;
the operation system stored in the accessing device, comprising:
an application program (AP) suitable for sending out a park command to the accessing device for parking the reading head of the accessing device; and
an advanced configuration and power interface (ACPI) suitable for receiving at least a third signal provided from the basic input/output system and providing at least a fourth signal; wherein
when the acceleration value is higher than the threshold value, the first signal is sent out to the embedded controller from the G-sensor, the second signal is sent out to the basic input/output system from the embedded controller, the third signal is sent out to the advanced configuration and power interface from the basic input/output system and the fourth signal is sent out from the advanced configuration and power interface to control the application program to send out the park command to the accessing device for parking the reading head of the accessing device.

2. The portable apparatus according to claim 1, wherein each acceleration value comprises an X axis acceleration value, a Y axis acceleration value and a Z axis acceleration value.

3. The portable apparatus according to claim 2, wherein the threshold values comprise a first threshold value, and the first threshold value comprises a first X axis threshold value, a first Y axis threshold value and a first Z axis threshold value such that the application program orders the embedded controller to control the G-sensor comparing the acceleration value with one of the first threshold values while the portable apparatus is connected to an AC power.

4. The portable apparatus according to claim 2, wherein the threshold values comprise a second threshold value and the second threshold value comprises a second X axis threshold value, a second Y axis threshold value and a second Z axis threshold value such that the application program orders the embedded controller to control the G-sensor comparing the acceleration value with one of the second threshold values while the portable apparatus is connected to a battery.

5. The portable apparatus according to claim 2, wherein the embedded controller further comprises a memory module storing the acceleration value.

6. The portable apparatus according to claim 5, wherein the threshold values comprise a third threshold values and the third threshold value comprises:
a third X axis threshold value which is an average value of the X axis acceleration values stored in the memory module;
a third Y axis threshold value which is an average value of the Y axis acceleration values stored in the memory module; and
a third Z axis threshold value which is an average value of the Z axis acceleration values stored in the memory module.

7. The portable apparatus according to claim 1, wherein the portable apparatus further comprises a monitor connected to the embedded controller such that if the embedded controller detects the portable apparatus to be turned around, the embedded controller turns around the image displayed on the monitor accordingly.

8. A control method of a portable apparatus having an electronic control system disposed in the portable apparatus, the electronic control system having a G-sensor and an embedded controller, the portable apparatus having at least an accessing device and a basic input/output system, the accessing device having a motor drive unit and storing an operation system, the operation system having an application program and an advanced configuration and power interface, the control method of the portable apparatus suitable for preventing the damage of the motor drive unit from abnormal acceleration, comprising:
initializing the G-sensor by the embedded controller;
sensing the acceleration of the portable apparatus with the G-sensor to provide at least an acceleration value to compare that if the acceleration value is higher than one of the threshold values stored in the G-sensor;
receiving the first signal provided from the G-sensor and providing at least a second signal by the embedded controller;
receiving the second signal and providing at least a third signal by the basic input/output system; and
receiving the third signal and providing at least a fourth signal by the advanced configuration and power interface to control the application program sending out a park command to the accessing device for parking the reading head of the accessing device.

9. The control method according to claim 8, wherein each acceleration value comprises an X axis acceleration value, a Y axis acceleration value and a Z axis acceleration value.

10. The control method according to claim 9, wherein the threshold values comprise a first threshold value and, the first threshold value comprises a first X axis threshold value, a first Y axis threshold value and a first Z axis threshold value such that the application program orders the embedded controller to control the G-sensor comparing the acceleration value with one of the first threshold values while the portable apparatus is connected to an AC power.

11. The control method according to claim 9, wherein the threshold values comprise a second threshold value and the second threshold value comprises a second X axis threshold value, a second Y axis threshold value and a second Z axis threshold value such that the application program orders the embedded controller to control the 0-sensor comparing the acceleration value with one of the second threshold values while the portable apparatus is connected to a battery.

12. The control method according to claim 9, wherein the embedded controller further comprises a memory module connected to the G-sensor and storing the acceleration value.

13. The control method according to claim 12, wherein the threshold values comprise
a third threshold value and the third threshold value comprises:
a third X axis threshold value which is an average value of the X axis acceleration values stored in the memory module;
a third Y axis threshold value which is an average value of the Y axis acceleration values. stored in the memory module; and
a third Z axis threshold value which is an average value of the Z axis acceleration values stored in the memory module.

14. The control method according to claim 8, wherein the portable apparatus further comprises a monitor connected to the embedded controller such that if the embedded controller detects the portable apparatus to be turned around, the embedded controller turns around the image displayed on the monitor accordingly.
